(19) United States
(12) Patent Application Publication
(10) Pub. No.: US 2007/0247118 A1
(43) Pub. Date: Oct. 25, 2007

(54) Method of end of discharge voltage measurement for battery with estimation thereof

(75) Inventor: Chang-Yu Ho, Hsinchu Hsien (TW)

Correspondence Address: BRUCE H. TROXELL, SUITE 1404, 5205 LEESBURG PIKE, FALLS CHURCH, VA, 22041, US

(73) Assignee: Neotec Semiconductor Ltd.

(21) Appl. No.: 11/702,199

(22) Filed: Feb. 5, 2007

(30) Foreign Application Priority Data
Feb. 9, 2006 (TW) 95104439

(51) Int. Cl. H02J 7/00

(52) U.S. Cl. 320/134

(57) ABSTRACT

A method of determining the end of discharge voltage, EDV2 and EDV0 of a battery according to loading current therefrom and the environmental temperature is disclosed. The methods comprises following steps: firstly, charging the battery until it is full and then discharging at a constant current and a first temperature; then plotting the first discharging curve. The battery is then recharged and discharged as above but at a second temperature. And then a second discharging curve is plotted. After that two sets of EDV2 and EDV0 are found from the first and second discharging curve. The resulted known values are then substituted into two empirical equations which are two variables (one variable is discharging current and the other is a temperature dependent variable) empirical equations. Thereafter two equations can be used to obtain the EDV2 and EDV0 for any given temperature and discharge current.

### FIELD OF THE INVENTION

The present invention is related to find an EDV (End of Discharge Voltage), particularly, to a method of determining EDV having estimation therein according to an environmental temperature and loading current.

### DESCRIPTION OF THE PRIOR ART

Battery is knows as a main power for most of probable electric device. For instance, the mobile phone, Notebook, PDA (personal digital assistance), Walkman, etc., all are relied on the battery to provide their power. The battery, however, saves only limited electrical capacity. As a probable device is turned on, the charges saved in the battery consumed will sustain until power off or the residue electrical capacity is not enough to support the probable device work properly. As the electricity saved in the battery is lower than a critical level, the battery will need to be discarded or recharged. Generally, for the earth environment and the average cost for a long time are concerned, choosing the rechargeable battery as the main power will be the best policy. A typical rechargeable battery can be recharged to replenish its electricity up to several hundreds to thundered times.

Surely, how long time a full-charged battery can support a probable device depends on the power consumption and time of power on of the probable device. It is also strongly related to the electron charge saving ability of a battery.

The capacity of a battery is known to mainly depend on the material therein and the memory effect thereof. The memory effect is a fact that the physical capacity of a battery saved is found to be gradually lower than its original has due to the probable device can not be completely discharged for a long time. The phenomenon is believed to be due to the properties of some elements. For example, the memory effect of Ni—Cd battery is found to be more serious than Ni-MH battery. The Li-polymer battery is thought to have least memory effect.

One characteristic of the rechargeable battery worth to note is the curve relationship between the terminal voltages versus the residue electrical capacities of a battery. Please refer to FIG. 1. It shows discharge curves at different temperatures. As shown in FIG. 1, two steeped points are found in each one discharge curve, respectively, at a point near a saturation point and the charges in the battery near empty. At the latter point the charges can be released are rare and the terminal voltage of the battery is plummeted. At this point, the terminal voltage is called End of Discharge Voltage, hereinafter is called EDV. When the terminal voltage of the battery equals to EDV, or called EDV2, the remaining capacity in the battery are about 7-8% of the full scale. The line 5 is plotted according to EDV2 of each discharge curve. It is found that EDV2 is not a constant value.

Besides, there is another parameter called EDV0 for the situation of the remaining capacity are completely empty i.e., 0% of the full scale. In fact, the battery voltage of the probable device will not be discharged to EDV0 or even EDV2 to avoid data loss risk in RAM (random access memory) of a probable device. Even more seriously, if the probable device is a medical appliance for a patent, the power loss will cause the patent falls into a dangerous situation immediately.

Hence, for a smart battery management system, it should at least have remaining capacity monitoring ability and issue an alarm signal to the user while the remaining capacity is close to 10% or 20%. Another additional preferred function for the smart battery management system is by turning off the power while reaching the EDV2 so as to avoid the battery dead.

Still, as shown in FIG. 1, the EDV2 of a battery is not a constant value. Typically, the EDV2 is changed with the battery aging, the loading current of the probable device, and an environmental temperature.

Thus an object of the present invention is to provide a method for determining EDV2 and EDV0 at any temperature and the discharge current.

### SUMMARY OF THE INVENTION

A method for determining EDV2 and EDV0 having corrections in accordance with an environment temperature is disclosed. The EDV2 is a voltage while curve of terminal voltage versus residue electrical capacity of a battery from smooth to steep. Its voltage is a value while the residue electrical capacity approximately equals to 7%-8% of the full scale and 0% for EDV0.

The method includes the following steps: At first, a battery is charged up to full and discharged by a constant current rate at a first environmental temperature and then plots a discharging curve 1; the battery is then recharged up to full again and discharged by the constant current rate at a second environmental temperature and then plots a discharging curve 2. Accordingly, two sets of EDV2 and EDV0 values are, respectively, found from the curve 1 and curve 2. And then the known values of two sets of EDV2 and EDV0, two environmental temperatures, and the loading current are then substitute into the empirical formulas (I) and (II):
EDV2=EMC*(256−(I_{discharge}/64+Q_{T})*EDV_gain/256)/256 (I)
EDV0=EMC*(256−(I_{discharge}/64+Q_{T})*EDV_factor/256)/256 (II)
where Q_{T}=[480−(T−5)*10]*8/256

Preferably, the two environmental temperatures are selected from temperatures:5° C.-25° C., and 45° C. and the discharging current is about 50-150% of the battery capacity for one hour discharge.

After that, the EMC, EDV_gain, and EDV_factor are obtained. Consequently, the empirical formulas (I) and (II) can use to find the EDV2 and EDV0 at an arbitrary loading environmental temperature and current loaded.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is discharging curves of a battery at various of temperatures showing the EDV2 and EDV0 are not a constant value but depends on the temperature and discharging current.

FIG. 2 is a flow chart for discharging curve measurement to follow.

FIG. 3 is a function block showing the measuring system for battery.

FIG. 4 shows RTC interrupt pulses.

### DESCRIPTION OF THE PREFERRED EMBODIMENT

As aforementioned descriptions in the background of the present invention, the EDV2 (7% of the full-charged capacity) is influenced by environmental temperature of the battery and sustained discharged current. It is thus desired to find a formula to estimate EDV2 and EDV0 at arbitrary environmental temperature and the sustained discharged current.

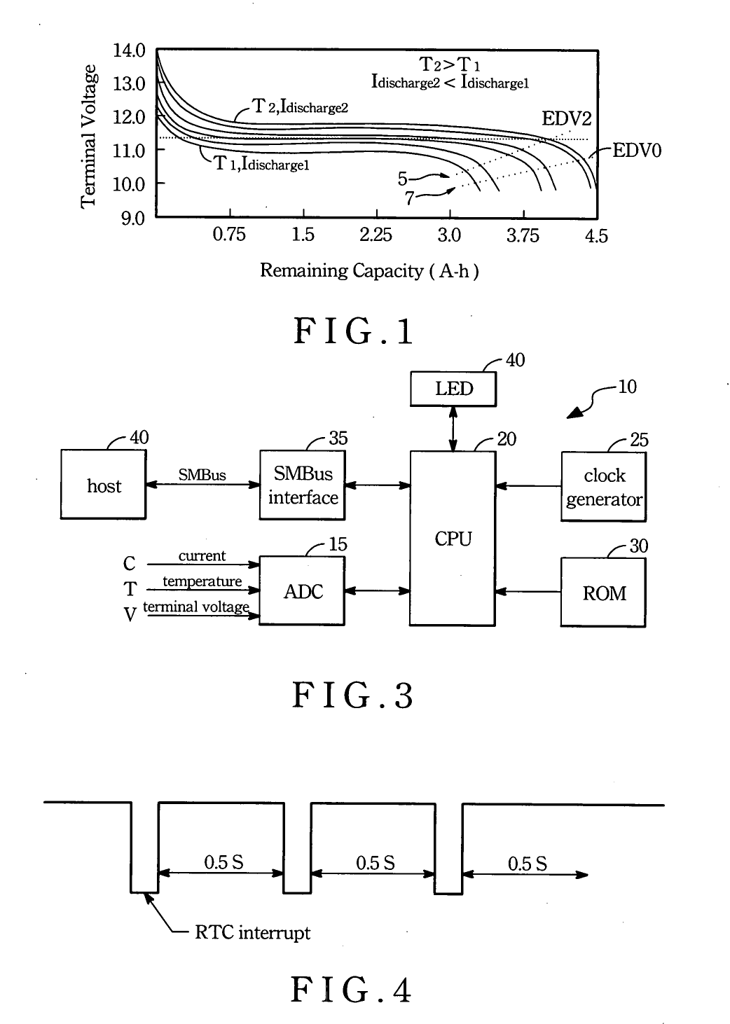

According to a preferred embodiment of the present invention, the EDV2 can be estimated from a empirical formula (I) depicted below and EDV0 can be estimated from a empirical formula (II) depicted below too. FIG. 1 shows a discharging curve typically for a battery, wherein, the x-axis is the remaining capacity of the battery and the Y-axis is the terminal voltage of the battery which may be one cell or a plurality of cells in series connected.

According to measurements of the present invention, the discharging curves are found that each can be divided into two piecewise of curves, which are, respectively, approximately consistent with the empirical formulas (or called estimated curve):
EDV2=EMC*(256−(I_{discharge}/64+Q_{T})*EDV_gain/256)/256; (I)
EDV0=EMC*(256−(I_{discharge}/64+Q_{T})*EDV_factor/256)/256; (II)

In the equations: I_{discharge} and Q_{T} are two variables, where Q_{T} is temperature related variable and I_{discharge} is a discharging current;
Q_{T}=[480−(T−5)*10]*8/256; and (III)

where the I_{discharge} is with unit of mA and T with unit of ° C. as putting into the equations.

Accordingly, the parameters, EMC, EDV_factor, and EDV_gain are coefficients of the two variable empirical equations and can be obtained by boundary conditions. The “EDV_factor’ is the slop of the estimated curve (II) and the “EDV_gain’ is the slop of the estimated curve (I).

The boundary condition is set at a constant discharge rate of about 40%-60% of the full scale battery capacity at a temperature range 5° C.-45° C. For instance, the discharging current is set to be 2200 mA for a fully charged battery 4400 mAh of a Notebook having a battery consisting of three cells in series.

Three sets of EDV2, EDV0 are determined from three discharging curves, respectively, at temperature of about 45° C., 25° C., and 5° C. and a constant discharge current I_{discharge} of about 50% of the full scale battery capacity for one hour discharge. Surely, the aforementioned boundary conditions are for illustrating convenient only but it does not intend to limit the claim scopes. Besides forgoing temperatures are environmental temperatures rather than the surface temperatures of the battery.

Therefore, three known values of Q_{T1}, Q_{T2}, Q_{T3} can be derived by equation (III) with T=5° C., 25° C., and 45° C., respectively.

Another known value I_{discharge} is 2200 mA. Equation (1) contains two unknown coefficients: EMC, and EDV_gain, and Equation (2) contains unknown coefficients: EMC, and EDV_factor. Principally, two boundary conditions would be thus enough to solve the equations (I) and (II).

Since the equations (I), (II), (III) are empirical equations. The extra one boundary set at room temperature is used for calibration while the empirical equations are departed from the real discharging curve. If the departure is out of a tolerated limitation, average values of EMC, EDV_factor, and EDV_gain coefficient are taken by averaging three sets of them derived from three pair boundary conditions.

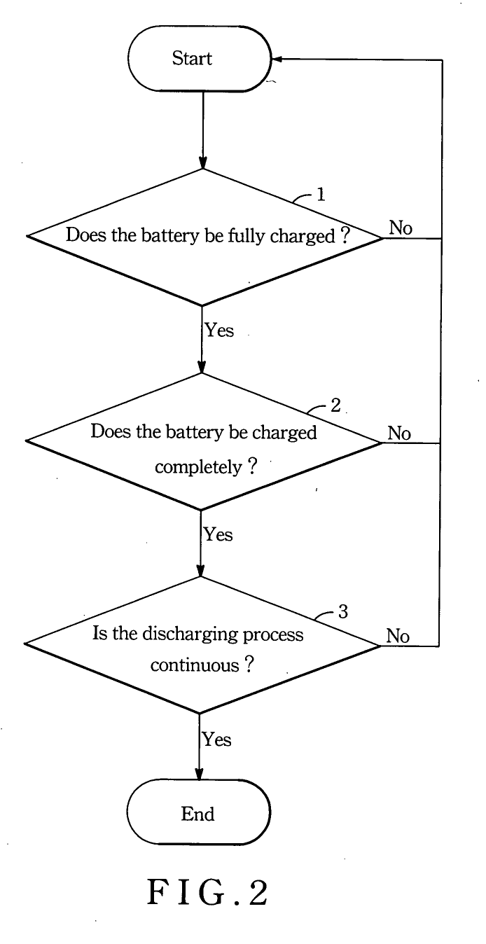

The discharging curve measuring processes should abide by flow chart listing in FIG. 2 to check if the discharging curve measurement is reliable.

Step 1: check if the electricity of the battery is fully charged;

Step 2: check if the battery is discharged completely;

Step 3check if the discharging processes are continuous, i.e., during the discharging processes, any charging operation is not allowable.

Step 4, check if the surface temperature of the battery is at least over 5° C. during the discharging process.

In the above testing steps, if the answer is No, the measuring result will be discarded.

According to a preferred embodiment of the present invention, the discharging data measurement is implemented by a measuring system 10, as shown in FIG. 3. The measuring system 10 includes an ADC (analog to digital coveter) 15, a CPU (central process unit) 20, a clock generator 25, ROM (read only memory) 30, a SMBus (smart battery management) interface 35, and LEDs (light emission diodes) 40. The SMBus interface 35 is connected with a host 38, a mother board or a charger of the Note Book. The clock generator 25 is provided for CPU 20 operation and will issue an interrupt pulse signal in a period of time, as is shown in FIG. 4. The time period showing in the FIG. 4 is 0.5 s. When a pulse low occurrence, it will trigger the interrupt pin of he CPU 20 to generate an interrupt. The interrupt is called RTC (real time interrupt) interrupt. When a RTC interrupt is occurred, the CPU will output the battery related information such as the surface temperature of the battery, loading current (or called discharging current and the digital terminal voltage of the battery through the ADC 15. The CPU 20 executes the command stored in the ROM 30 to calculate the residue electrical capacity stored in the battery according the digital terminal voltage. The results are stored in the registers or memory of the SMBus interface 35. The SMBus interface 35 is then timely outputting the residue electrical capacity data either by a LED display or just by an indicator of LEDs.

In more detailed descriptions, as a current flow through the loading resistor, the analog voltage is measurement by taking the voltage drop of the resistor and then converted it to digital signal by ADC 15. The surface temperatures of the battery are measured by any temperature sensor such as thermal couple. The voltage detected by the thermal couple is also converted to digital signal through ADC 15. Aforementioned digital data are then calculated by programs stored in the ROM 30 to obtain the residue electrical capacity and surface temperature.

A battery capacity is known to use “mAh” (10⁻³ A-hour) as unit. Since it relates to the real time, the time of each RTC interrupt is thus demanded to be calibrated so as to correct monitoring the residue electrical capacity of a battery. The period of the RTC interrupt is thus calibrated by means of a program stored in ROM. After accumulating a number of RTC interrupts, for example 120 times, the total time costs are then calibrated by reference clocks. In accordance with the present invention, a low cost crystal oscillator is preferred to act as a reference clock generator. The residue electrical capacity of the battery is:

Residue electrical capacity=total charges after fully charged+charges of flowing in−charges of flowing out−self-releasing charges of the battery.

The total charges are integral result of current versus time. The current can be calculated by a voltage drop across the loading resistor. If a voltage difference of a detected voltage minus a reference voltage is negative, the voltage difference is stored in the DC (discharge counter) of a battery protective IC. Otherwise, the voltage difference is stored in the CC (charge counter) of a battery 5 protective IC. The residue electrical capacity can be calculated according to a voltage difference between CC and DC.

The benefits of the present invention are:

(1). The calibrated end of voltage, EDV2 and EDV0 considering factors of both the environment temperature and loading 10 current, can be, obtained by two-variable empirical equations along with a simple measurement system 10.

(2) Only a low level CPU is used in the measuring system according to the present invention. A low cost battery capacity management system can be achieved.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A method of determining end of discharge voltage (EDV2, and EDV0) having calibration according to an environmental temperature and loading current, said EDV2 being a inversion point of a discharging curve, and said EDV0 being an end point of the discharge curve, said method comprising the steps of:
(a) charging a battery fully until said battery is saturated;
(b) discharging said battery continuously by a predetermined constant discharging current I_{discharge} at a first predetermined environmental temperature Q_{T1};
(c) plotting a first discharging curve according to terminal voltages of said battery versus residue electrical capacities;
(d) finding a first set of EDV2 and EDV0 from said first discharging curve;
(e) recharging said battery fully by the predetermined constant discharging current I_{discharge} at a second predetermined environmental temperature Q_{T2};
(f) plotting a second discharging curve according to terminal voltages of said battery versus residue electrical capacities;
(g) finding a second set of EDV2 and EDV0 from said second discharging curve;
(h) deriving EMC, EDV_gain, and EDV_factor by equations: (I), (II), (III)
EDV2=EMC*(256−(I_{discharge}/64+Q_{T})*EDV_gain/256)/256 (I)
EDV0=EMC*(256−(I_{discharge}/64+Q_{T})*EDV_factor/256)/256 (II)
Q_{T}=[480−(T−5)*10]*8/256 by putting known values of said first set of EDV2 and EDV0, second set of EDV2 and EDV0, and Q_{T}=said Q_{T1}, QT₂; and (III)
whereby said EDV2, and EDV0 can be obtained at any I_{—discharge}, any environmental temperature by said equations: (I), (II), (III).

2. The method of determining end of discharge voltage having calibration according to claim 1 wherein said first, second predetermination environmental temperature are selected from two from a temperature range 5° C.-45° C.

3. The method of determining end of discharge voltage having calibration according to claim 2 further comprising obtaining a third set of EDV2 and EDV0 using the steps of (a) to (c) with the same predetermined constant discharging current I_{discharge} but difference environmental temperature selected from one from said temperature range 5° C.-45° C. so as to obtain average values of EMC, EDV_gain, and EDV_factor.

4. The method of determining end of discharge voltage having calibration according to claim 1 wherein said predetermined constant discharging current I_{discharge} is about 50-150% total electrical capacity of said battery for one hour discharge.

5. The method of determining end of discharge voltage having calibration according to claim 1 wherein a surface temperature of said battery during said steps of discharging process should be at least larger than 5° C.
